(19) United States
(12) Patent Application Publication
(10) Pub. No.: US 2011/0191241 A1
(43) Pub. Date: Aug. 4, 2011

(54) METHOD OF PROVIDING AN ACCOUNT THAT EMPLOYS A BUFFER AGAINST OVERDRAFTS

(75) Inventors: Joe Blain, Milton, MA (US); Jeffrey Jacocks, Jamaica Plain, MA (US); Andrea Tittel, Boston, MA (US)

(73) Assignee: CITIZENS FINANCIAL GROUP, INC., Providence, RI (US)

(21) Appl. No.: 12/698,742

(22) Filed: Feb. 2, 2010

(51) Int. Cl. G06Q 40/00

(52) U.S. Cl. 705/42; 705/39

(57) ABSTRACT

A method and system is provided for establishing a buffer to protect a banking customer against over drafting a bank account. The invention provides a bank account that includes a buffer attached thereto wherein the buffer allows the account holder to exceed their account value within the predetermined range without risk of incurring overdrafts or the resulting overdraft fees associated therewith. A customer establishes a banking account that contains a monetary balance therein. A buffer amount is assigned to the account. The buffer is a monetary value in excess of the balance within the account. As debits are settled against the account they are deducted from the balance. Should one or more transactions cause the value of the account to drop below the balance the account is in an over draft condition, but provided the overdraft amount is less than the buffer, the traditional overdraft fees are waived.

### BACKGROUND OF THE INVENTION

The present invention relates generally to a method and system for establishing a buffer to protect against over drafting a bank account. More specifically, the present invention relates to a bank account that includes a buffer attached thereto wherein the buffer allows the account holder to exceed their account value within the predetermined range without risk of incurring overdrafts or the resulting overdraft fees associated therewith.

Consumers today are rapidly changing the manner in which they conduct monetary transactions. Most consumers are moving away from a transaction wherein they pay for goods and services with cash or checks. Instead these consumers are turning to the use of electronic transaction cards in the form of credit or debit cards. Consumers often find themselves using such electronic transaction cards for completing even the smallest everyday purchase, such as buying their morning coffee. Such electronic transaction cards then allow the customer to complete the transaction whereby money is transferred from a consumer account linked to the card to the provider of the goods and/or services. Often however this frequent use of electronic transaction cards for numerous purchases each day creates a flurry of activity that can be difficult for the consumer to track. When the balance in the account linked to the electronic transaction card gets low, an unsuspecting consumer can rack up several small charges that overdraft their account in turn accruing overdraft fees. In this regard there have been many recent news stories that include accounts of consumers, who in charging a coffee, accrued overdraft charges that ultimately resulted in that one coffee costing a consumer over $30 by the all of the charges were added up.

Further, there is a growing popularity surrounding the use of online banking to assist consumers in managing their finances and to receive and pay bills. These online interfaces allow consumers to electronically track various accounts and other financial endeavors. Additionally, the user can receive electronic billing in their account or if the user receives a paper bill, enter them into their computers, and manage payment of the bills electronically. The consumer then creates payment instructions in the online banking interface. For recurring bills, such as a mortgage, the consumer can also arrange so-called “direct debit” payment systems in which routine payment amounts are automatically debited from the consumer's bank account and credited to the biller's bank account on agreed transaction dates. The problem that arises here is that the accounts used in this fashion are typically the same accounts that are tied to the electronic transaction cards described above thereby making the flow of transactions in the account even more dynamic.

This dynamic flow of transactions through the user's account may often be difficult to manage or keep careful track of. While the automated computer systems maintain account balances with precision a consumer may lose track of a few purchases that they made along the way resulting in an overdraft condition in their bank account. In turn, each new transaction generates an overdraft and the associated fees and further some of the bills that were scheduled to be paid may not be paid because there were not sufficient funds in the account. One can easily see that a few small missteps that result in an overdraft can quickly become expensive and damaging for a consumer.

Accordingly, there is a need for a method and system that establishes a buffer to protect against over drafting a bank account. There is a further need for a method and system that establishes a bank account that includes a buffer attached thereto wherein the buffer allows the account holder to exceed their account value within a predetermined range without risk of incurring overdrafts or the resulting overdraft fees associated therewith.

### BRIEF SUMMARY OF THE INVENTION

In this regard, the present invention provides a method and system for establishing a buffer to protect against over drafting a bank account. More specifically, the present invention provides a bank account that includes a buffer attached thereto wherein the buffer allows the account holder to exceed their account value within the predetermined range without risk of incurring overdrafts or the resulting overdraft fees associated therewith.

In the context of the method and system of the present invention a customer establishes a banking account such that the banking account contains a monetary balance therein. While in the preferred embodiment, the banking account is an account that includes online bill payment features, direct deposit and access via an electronic transaction card such as an ATM or debit card, these features are not required for the most basic form of the inventive concept. A buffer amount is predetermined and assigned to the account. The buffer amount represents a monetary value that is in excess of the monetary balance within the account. As debits are settled against the banking account they are deducted from the monetary balance. Should one or more transactions cause the value of the account to drop below the monetary balance when settlement occurs the account would be in an over draft condition as was the case in the prior art. However, in the present invention provided the overdraft amount is less than the buffer, the traditional overdraft fees are waived.

In operation, the method and system of the present invention prevents the situation as was described above wherein a cup of coffee ends up costing a banking customer in excess of $30. Provided that the customer then deposits additional funds into their account to resolve the overdraft condition, no additional fees will be charged and the account will continue to operate in the traditional manner paying bills and settling transactions.

It should also be appreciated that in the context of the present invention, a fee may be established for this account feature. Further, the fee may be structure in a manner that different customers may be charged different or even no fees depending on the overall banking services that they use.

Accordingly, it is an object of the present invention to provide a method and system that establishes a buffer to protect a banking customer against over drafting a bank account. It is a further object of the present invention to provide a method and system that establishes a bank account that includes a buffer attached thereto wherein the buffer allows the account holder to exceed their account value within a predetermined range without risk of incurring overdrafts or the resulting overdraft fees associated therewith.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a flow chart depicting operation of the method and system of the present invention; and

FIG. 2 is a schematic of a computer implemented system to support operation of the method and system of the present invention.

### DETAILED DESCRIPTION OF THE INVENTION

Now turning to the method and system of the present invention in detail. As can be understood, the present invention most generally provides a method and system for establishing a buffer to protect against over drafting a bank account. More specifically, the present invention provides a bank account that includes a buffer attached thereto wherein the buffer allows the account holder to exceed their account value within the predetermined range without risk of incurring overdrafts or the resulting overdraft fees associated therewith.

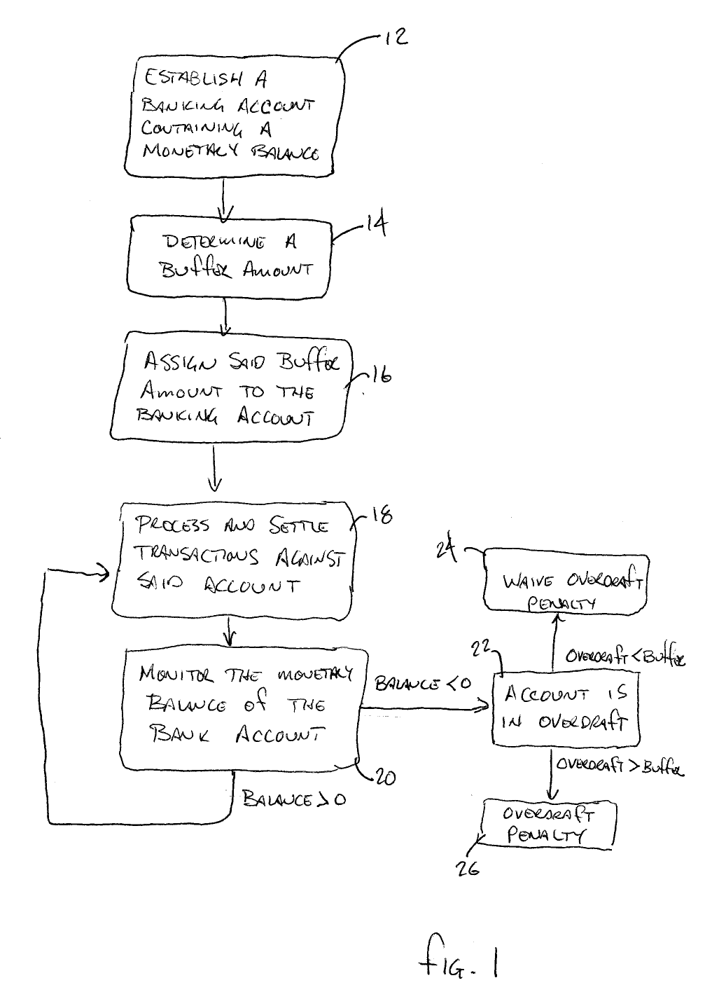

Turning now to FIG. 1, the method and system of the present invention is illustrated in a flow chart wherein a customer establishes a banking account such that the banking account contains a monetary balance therein 12. While in the preferred embodiment the banking account is an account that includes online bill payment features, direct deposit and access via an electronic transaction card such as an ATM card, a debit card, or a prepaid transaction card, these features are not required for the most basic form of the inventive concept. Further, the banking account is preferably a debit account or a checking account, but also may be a money market account. A buffer amount is predetermined 14 and assigned 16 to the account. The buffer amount represents a monetary value that is in excess of the monetary balance within the account. As debits are settled against the banking account 18 they are deducted from the monetary balance within the account. As transactions are processed, the monetary value of the account is monitored 20. Should one or more transactions cause the value of the account to drop below the monetary balance when settlement occurs, the account would be in an overdraft condition 22 as was the case in the prior art. However, in the present invention, if the overdraft amount is less than the predetermined buffer, the traditional overdraft fees are waived 24. On the other hand, should additional transaction cause the overdraft amount exceed the buffer amount the traditional overdraft penalties apply 26 to those transactions that cause the balance to exceed the buffer. Similarly, if the account begins an accounting day with a balance that is overdrawn beyond the buffer and transactions continue to settle into the account no fees are waived on the incoming transactions.

In operation, the method and system of the present invention prevents the situation as was described above wherein a cup of coffee ends up costing a banking customer in excess of $30. Provided that the customer then deposits additional funds into their account to resolve the overdraft condition, no additional fees will be charged and the account will continue to operate in the traditional manner paying bills and settling transactions.

It should also be appreciated that in the context of the present invention, a fee may be established for this account feature. For example, the bank service provider may charge a monthly fee for a customer to have this feature activated on their account. Further, the fee may be structured in a manner that different customers may be charged different or even no fees depending on the overall banking services that they use. For example, a customer of a basic checking account may pay a nominal fee per month to have this feature activated on their account while a consumer of a top tier account bundle that includes several accounts, bank service features and minimum maintained balances may receive this feature for no charge.

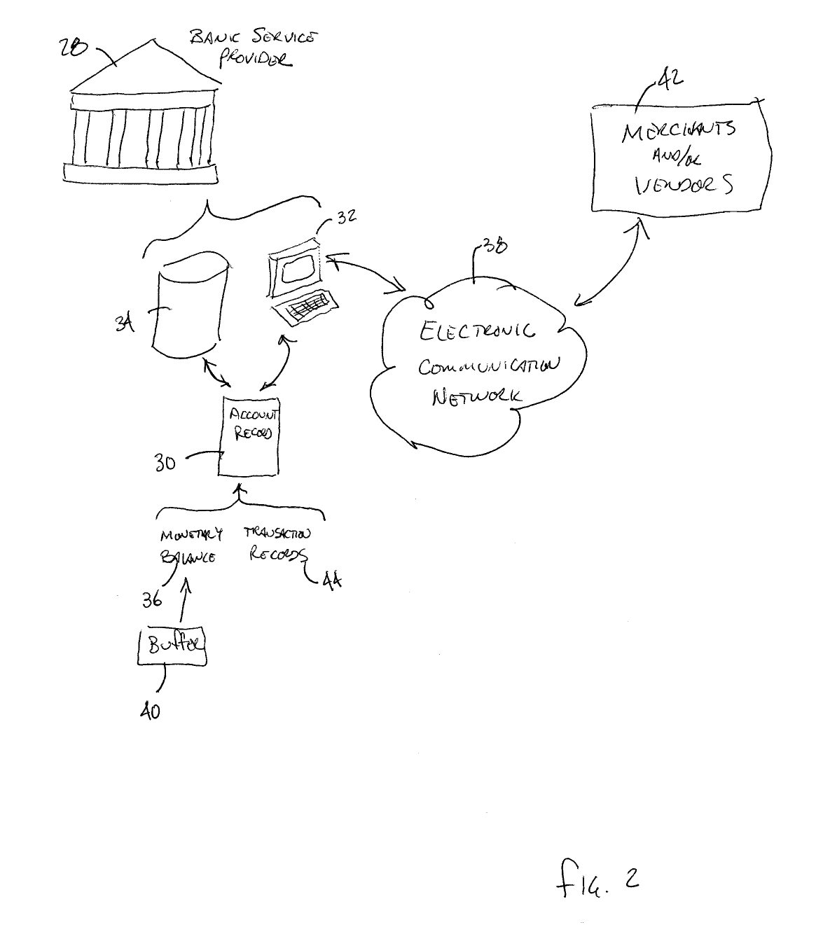

Turning to FIG. 2, the present invention is illustrated in the context of a computer implemented system wherein a customer establishes a banking account at a bank service provider 28 that resides as a record 30 on a computer server 32 or database system 34. The account record 30 contains a monetary balance 36 therein that is recorded and tracked within the record 30 within the computer server 32 or database 34. In the preferred embodiment the computer server 32 or database system 34 is connected to an electronic communications network 38 that, in turn, allows electronic access to the account record 30. It is preferred that the banking account is established in a manner that allows electronic access thereto via the electronic communications network for the purpose of online bill payment features and access via an electronic transaction card such as an ATM card, a debit card or a prepaid transaction card. As stated above, however, these features are not required for the most basic form of the inventive concept.

It is known in the prior art that as transactions are processed via the electronic communications network 38, the account 30 against which the transaction is to be settled is polled to determine whether sufficient funds reside in the account at the time of the transaction. While generally if the monetary balance in the account is insufficient to cover the transaction, the transaction will be refused. However, the process is generally dynamic in that a hold is placed against the account at the time of the transaction, but settlement actually occurs at a time in the future when the actual transaction records and funds are exchanged between the bank service provider and the merchant processing the transaction. Further, bank service providers may authorize a transaction based on funds currently in an account that are subsequently withdrawn by non-electronic transactions such as the cashing of a check or an in bank withdrawal. Accordingly, it is possible that in this dynamic environment that the actual settled balance in the account may drop below the funds required to settle all of the outstanding transactions at any given time.

To overcome the above problem, once the account is established, a buffer amount 40 is predetermined and assigned to the account. The buffer amount 40 represents a monetary value that is in excess of the monetary balance 36 within the account. As debits from merchants or vendors 42 are processed via the electronic communications network 38 and settled as transaction records 44 against the banking account 30 they are deducted from the monetary balance 36 within the account. Should one or more transactions cause the value of the account 30 to drop below the monetary balance 36 when settlement occurs, the account 30 would be in an over draft condition as was the case in the prior art. However, in the present invention provided the overdraft amount is less than the predetermined buffer 40, the traditional overdraft fees are waived.

Another feature that may be provided within the method and system of the present invention is electronic balance notification. Customers may elect to have text messages or emails sent to them when they approach the buffer, when they are nearing the buffer limit and when they exceed the buffer amount.

It can therefore be seen that the present invention provides a system and method that establishes a buffer to protect a banking customer against over drafting a bank account, wherein the buffer allows the account holder to exceed their account value within a predetermined range without risk of incurring overdrafts or the resulting overdraft fees associated therewith. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A method for maintaining a banking account that includes a buffer to protect against over drafting, comprising:
establishing a banking account at a bank service provider that contains a monetary balance therein;
assigning a buffer amount to said account;
processing transactions for settlement against said account, said transactions adding to or subtracting from said monetary balance;
monitoring said monetary balance to determine whether said monetary balance drops below a zero value thereby placing said banking account into an overdraft condition; and
waiving any consequences associated with said overdraft condition provided said monetary balance does not drop below a zero value by more than the amount of said assigned buffer amount.

2. The method of claim 1, wherein said banking account is an account that includes online bill payment features and access via an electronic transaction card.

3. The method of claim 2 wherein said electronic transaction card is selected from the group consisting of: ATM card, prepaid transaction card and debit card.

4. The method of claim 1, wherein said banking account is selected from the group consisting of: a debit account, a checking account and a money market account.

5. The method of claim 1, wherein a fee is charged against said monetary value of said account in exchange for maintaining the assignment of said buffer amount to said account.

6. The method of claim 5, wherein said fee is waived if the customer utilizes a bundle of services offered by said bank service provider.

7. A computer implemented system for maintaining a banking account that includes a buffer to protect against over drafting, comprising:
a computer server capable of storing records and processing transactions, said computer server being connected with an electronic communication network, said computer server containing at least one record relating to a banking account that contains a monetary balance therein and a buffer amount assigned to said account,
wherein transactions for settlement against said account, are transmitted to said computer server via said electronic communications network such that a monetary value of said transactions is added to or subtracted from said monetary balance,
wherein said computer server monitors said monetary balance to determine whether said monetary balance drops below a zero value thereby placing said banking account into an overdraft condition and waives any consequences associated with said overdraft condition provided said monetary balance does not drop below a zero value by more than the amount of said assigned buffer amount.

8. The computer implemented system of claim 7, wherein said banking account is an account that includes online bill payment features and access via an electronic transaction card.

9. The computer implemented system of claim 8 wherein said electronic transaction card is selected from the group consisting of: ATM card, prepaid transaction card and debit card.

10. The computer implemented system of claim 7, wherein said banking account is selected from the group consisting of: a debit account, a checking account and a money market account.

11. The computer implemented system of claim 7, wherein a fee is charged against said monetary value of said account in exchange for maintaining the assignment of said buffer amount to said account.

12. The computer implemented system of claim 11, wherein said fee is waived if the customer utilizes a bundle of services offered by said bank service provider.
